(19) United States
(12) Patent Application Publication
(10) Pub. No.: US 2006/0040219 A1
(43) Pub. Date: Feb. 23, 2006

(54) Silver halide color photographic material

(75) Inventor: Kuniaki Uezawa, TOKYO (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA PHOTO IMAGING, INC., TOKYO (JP)

(21) Appl. No.: 10/533,545

(22) PCT Filed: Nov. 20, 2002
(86) PCT No.: PCT/JP02/12109

§ 371 Date: May 2, 2005

(51) Int. Cl. G03C 1/46

(52) U.S. Cl. 430/502

(57) ABSTRACT

The present invention provides a silver halide color photographic material having a relatively low silver content suitable for digital print, leading to print quality superior in contrast and color reproduction is attained irrespective of camera quality used for picture-taking. The silver halide color photographic material, after having been processed, satisfies the following equation (1) which is calculated for under-exposure, correct exposure and over-exposure and any one of the color-sensitive layers satisfies the following equations (2) and (3) with respect to gradients (γU, γN, γO) for under-exposure, correct exposure and over-exposure.
Crm≧1045−log₁₀S×75 (1)
0.92≦γU/γN≦1.05 (2)
0.92≦γO/γN≦1.05 (3)

### TECHNICAL FIELD

The present invention relates to a silver halide color photographic material capable of providing print quality of superior contrast and color reproduction and having a relatively low silver content suitable for digital printing.

### TECHNICAL BACKGROUND

Along with developments of techniques for silver halide photographic material for general camera use (hereinafter, also denoted simply as photographic materials or negative film), photographic materials appeared on the market one after another, having a higher speed than ISO 100 which was generally used.

On the other hand, there were also offered on the market various kinds of cameras for use in photographing, such as a single-lens reflex camera regarded as a high-grade instrument, a compact cameral having a zooming function, and simple cameras such as fixed-focus, fixed-aperture or fixed shutter speed cameras and lens-fitted film. However, the percentage of appearance of picture scenes deviated from correct exposure such as under-exposure scenes and over-exposure scenes rose in cameras having no exposure control mechanism, leading to causes of resulting in a lowering of print productivity or finished print quality in photofinishing laboratories. There is desired an immediate response thereto.

In view of the foregoing problems in regard to silver halide color photographic material, when under-exposed negative film is printed, there results a lowered print quality such that density expressiveness (or tone reproduction) of the negative is deficient in highlight and shadow areas with respect to the density of the subject so that raising the density of the subject simultaneously increases the entire density, becoming darker; to the contrary, when the entire density is lowered, the density of the subject is also lowered and the image becomes blurred, resulting in deteriorated color reproduction and leading to a print image unacceptable for observation. Under such situations, the allowable range of an appropriate print density becomes extremely narrow and printing becomes difficult.

Under-exposed picture taking scenes easily appear not only in, for example, room-light or night photographing, scenes having a relatively high dark proportion and the use of a simple camera, but also in the case of what is generally called “photographing against light”, for example, the subject being darker than the lighted background such as the sky. In such photographing, the photographer's understanding of picture-taking being performed in a dark scene is deficient and the obtained prints are often finished in under-exposure. Accordingly, a great difference in print quality exists between photographer's understanding or expectation and the finished prints. Specifically, such a case has proved to be the cause for many quality claims from the results of a survey.

The photographic speed of a system of picture-taking as described above is called an effective speed. It is common knowledge that the effective speed of a negative-positive system by using color negative film and color negative paper may be associated with but cannot be simply correlated to a conventional color negative film speed, as defined in ISO standard (hereinafter, also denoted as ISO speed).

Methods for solving the foregoing print quality problem of under-exposed scenes include a means for enhancing the ISO speed of color negative film. For instance, the speed of a silver halide emulsion is greatly dependent of silver halide crystal sizes so that enhancement of the speed can be achieved by the use of a silver halide emulsion of large sized grains and is technically easy, which are commonly known and reported in literature, and are generally practiced. Further, the foregoing problems of under-exposed scenes are also produced similarly in over-exposed scenes.

A single channel type printer installed with a scanner (hereinafter, also denoted simply as 1ch. printer) can perform finer scanning (image scanning) of negative images than before, by using a CCD camera and more appropriate exposure control can be achieved by taking the pattern analysis of each individual scene into account. However, the print yield cannot be much enhanced even by using such a printer instrument and it is the present state that quality of finished prints, specifically color reproduction is by no means at a satisfactory level.

Although the print yield was slightly enhanced through recent development of printer techniques, further improvement is desired under present conditions.

The percentage of appearance of under-exposed and over-exposed scenes is high in the present negative-positive printing method, specifically overall image quality of an under-exposure scene, particularly color reproduction is markedly inferior to that of a normal exposure or over-exposure scene, so that further enhanced image quality of under-exposure scene is desired with respect to enhancement of overall print image quality or a print yield.

It is known that sharpness and graininess greatly affect overall image quality, as described in literature (for example, “Shashinkogaku no Kiso (Ginen-shashin)” published by Corona-sha). For example, an image enhancement method by employing an RMS granularity in the vicinity of correct exposure is disclosed in JP-A No. 10-268467 (hereinafter, the term JP-A refers to Japanese Patent Application Publication). However, overall image quality of an under-exposed scene is different from that of normal exposure scene and cannot be accounted for only by sharpness and graininess. Further, in order to enhance image quality, for example, an increased silver coating amount or the use of material such as a coupler in a large amount results in a cost increase and it is difficult to say to be an efficient method.

On the other hand, in addition to printers employing a traditional exposure control system, there are emerged printers of a digital or hybrid system, in which density data of an image is read as digital data and subjected to image processing, followed by performance of printing, based on the obtained data.

However, when the printers described above were used, compression or lack of information at the time of digitization (or quantization) of the density proved to be a problem, in addition to the foregoing problems of the exposure control system in under- and over-exposure. This is due to the fact that while the negative image density usually has data up to 3.5 (or more than 300 gradations), an image of the standard format has to be compressed to 256 gradations at the time of quantization, in which a part of the data is appropriately converted.

Specifically, a disadvantage caused by the foregoing is that it produced problems such that when an under-exposed, low contrast scene is converted to an appropriate contrast, inconsistency of the negative density range and the range of quantization forcedly enhances a contrast to an extent more than that needed by a human being, resulting in deteriorated color reproduction or excessively softened contrast in over-exposed, high contrast scenes in which luminance of the main subject is alienated from that of the background. As a result, it turned out that the most of the dynamic range was not used, often resulting in an unnatural image print of low colorfulness and print level variation frequently occurred. Complication of algorithms improved a part of phenomena but resulted in a lowering of productivity per time and it was therefore impractical under present conditions.

It was further proved that high-speed processing or diversification of processes, as trends in the photographic market resulted in a partial lowering in SN ratio at the time of digitization, in silver halide photographic material using at least a prescribed amount of silver. It is assumed that when negative-to-positive conversion of a negative image digital printing is undergone to perform digital printing through various processes, the case of desilvering being insufficient during the process, for example, exhaustion of a bleaching solution results in metallic silver remaining on the coated film, leading to a lowering of the SN ratio. When metallic silver remains in developed negative film and the negative film is scanned by a printer, positioning of individual picture is accurately performed. Specifically in a scene picture-taken by a low-priced camera of low transportation accuracy, data of portions non-relevant to the actual scene (minimum density) is carried in image processing, so that positive image processing cannot be achieved by effectively employing the dynamic range of positive image data (8 bit or more, up to 16 bit), resulting in prints having incompatible gradation, as compared to one obtained by a conventional analog type printer.

To solve the foregoing problems, there have been proposed silver halide color photographic materials or cameras to enhance finished print quality, specifically color reproduction or tone reproduction.

For example, a silver halide color photographic material for camera use was proposed in which the latitude for white light exposure, the latitude for red light exposure and the green gradation are set within specified conditions, whereby superior print quality can be stably achieved from negative films of various exposure conditions (as disclosed in, for example, patent document 1). There was also proposed a method for improving color reproduction and sharpness without vitiating process stability, in which the ratio of green gradation for white light exposure to green gradation for green light exposure is controlled within a specific relation by using a silver halide color photographic material exhibiting a specific spatial frequency (as disclosed in, for example, patent document 2).

There was further proposed a lens-fitted film unit in which a simple camera having a shutter of a fixed shutter speed at a fixed focal distance and a fixed aperture value was installed and highly satisfactory photographic prints were obtained with reduced frequencies of under-exposure and over-exposure even in such a simple camera, by allowing a system speed index to fall within the range from 0 to 4.5 (as disclosed in, for example, patent document 3).

However, none of the foregoing proposed methods can sufficiently display advantageous effects even by using any one of from a high-grade camera to a simple camera and the use of films differing in effective speed results in different effects. And specifically with respect to color reproduction, it is hard to say that satisfactory quality is achieved under all conditions.

Patent document 1:
JP-A No. 9-90575 (scope of patent claims)

Patent document 1
JP-A No. 2000-321727 (scope of patent claims)

Patent document 1
JP-A No. 2000-47280 (scope of patent claims)

### DISCLOSURE OF THE INVENTION

The foregoing object of the invention can be accomplished by the following constitutions.

(1) A silver halide color photographic material comprising on a support a red-sensitive layer, a green-sensitive layer and a blue-sensitive layer, wherein after having been subjected to photographic color processing, the photographic material satisfies equation (1) below with respect to Crm values which are defined as below and calculated for under-exposure, correct exposure and over-exposure; the red-sensitive layer, the green-sensitive layer and the blue-sensitive layer each satisfy the following equations (2) and (3) with respect to gradients (γU, γN, γO) at under-exposure, correct exposure and over-exposure;
Crm≧1045−log₁₀S×75 equation (1)
wherein S is a nominal speed of the photographic material, and Crm is defined as follows:

when a Macbeth color chart (of 24 squares) having been photographed with the photographic material using a camera under a sun light source having a color temperature of 4800° K at each of a correct exposure (N), an under-exposure (U) of being 2 stops down from the correct exposure and an over-exposure (O) of being 2 stops up from the correct exposure and after having been subjected to color processing, the photographic material having exposed at each of the foregoing exposures is printed on a color print paper with respect to the respective exposures under such an exposure condition that N5 gray of the Macbeth color chart (gray chart of 18% reflectance) gives values of L*=50, a*=0 and b*=0, metric chroma C_{ab}* values are determined for Blue, Green, Red, Yellow, Magenta and Cyan of the color chart at the respective exposures, and the Crm value is the total value of the metric chroma values at the under-exposure condition, correct exposure condition and the over-exposure condition;
0.92≦γU/γN≦1.05 equation (2)
0.92≦γO/γN≦1.05 equation (3)
wherein when a density function curve (D-logE) indicating a relationship between exposure and color density is prepared for the processed photographic material, the γU, γN and γO are each determined by the following definition:
γU: a slope (tanθ) of a straight line connecting an exposure point (−0.1−log₁₀S) and an exposure point (0.9−log₁₀S),
γN: a slope (tanθ) of a straight line connecting an exposure point (0.5−log₁₀S) and an exposure point (1.5−log₁₀S),
γO: a slope (tanθ) of a straight line connecting an exposure point (2.0−log₁₀S) and an exposure point (3.0−log₁₀S);

(2) A silver halide color photographic material comprising on a support a red-sensitive layer, a green-sensitive layer and a blue-sensitive layer, wherein after subjected to color photographic processing, the photographic material satisfies the following equation (4) with respect to a quality value QC as defined as below; the red-sensitive layer, the green-sensitive layer and the blue-sensitive layer each satisfy the foregoing equation (2) with respect to gradients (γU, γN, γO) at under-exposure, correct exposure and over-exposure;
QC≧15.982×S⁻⁰³⁷⁸ equation (4)
wherein S is a nominal speed of the photographic material, preferably from 100 to 800; and QC is defined as below;

when a Macbeth color chart (24 squares) having been photographed with the photographic material using a camera under a light source having a color temperature of 4800° K at an under-exposure of being 3 stops down from normal exposure in which the aperture of the camera is reduced by 3 steps from the normal exposure and after having been processed, the photographic material is exposed to obtain a print under an exposure condition so that N5 gray of the Macbeth color chart (gray chart of 18% reflectance) gives values of L*=50, a*=0 and b*=0 and 18 colors other than gray are subjected to chromaticity measurement, the quality value of QC is calculated according to the following equation (5):
QC=(Cr+Ch)/2 equation (5)
wherein Cr and Ch are defined in the following equations (6) and (7):
Cr=20×log₁₀(Cr0) equation (6)
Ch=7.0−3×log₁₀(Ch0) equation (7)
wherein Cr0 represents a ratio of a mean metric chroma value C_{ab}* calculated from chromaticity values of 18 colors of the Macbeth color chart to a mean metric chroma value C_{ab}* calculated from chromaticity values of 18 colors of the print of the Macbeth color chart; and when from color vectors of the 18 colors of the Macbeth color chart and the respective color vectors of the print corresponding to the Macbeth color chart, chromaticity fluctuations for the respective colors are represented by an angle between the foregoing color vectors for each of the 18 colors, and a mean value of the chromaticity fluctuations is designated as Ch0;

(3) The silver halide color photographic material described in (1) or (2), wherein the total coating weight of silver is a silver amount B (g/m²) as defined in the following equation (8):
B≦10.0−10^{(-0.005×S+0.85)} equation (8)
wherein S is a nominal speed of the photographic material;

(4) The silver halide color photographic material described in any of (1) to (3), wherein the nominal speed S is from 100 to 800.

### PREFERRED EMBODIMENT OF THE INVENTION

The inventors of this application have made studies in light of the problems described above and as a result of detailed analysis of density distribution of photographed scenes taken by general users using various cameras, it was proved that in algorithm for exposure control at specified speed of a printer, normal exposure conditions were easily determined when color reproduction of under-, normal and over-exposures of photographic material was higher than the given value for the film speed.

Efficient achievement of enhancement of image quality has been a proposition for years and development of a method thereof has been consistently desired. As a result of the inventors' study, it was further proved that a dominant factor of print quality was not only graininess but also when a quality value relating to color reproduction, a Crm value or QC value was more than the prescribed values and the gradation ratio in the under-, normal and over-gradation regions was set within a specific condition, print quality was recognized as being superior; and the quality values depend of nominal speed of the used film. Thus, the present invention has come into being as a result of the foregoing.

The silver halide color photographic material according to the invention comprises on a support a red-sensitive layer, a green-sensitive layer and a blue-sensitive layer, characterized in that after subjected to color photographic processing, the photographic material satisfies equation (1) below with respect to Crm values which are defined as below and calculated for under-exposure, correct exposure and over-exposure; the red-sensitive layer, the green-sensitive layer and the blue-sensitive layer each satisfy the following equations (2) and (3) with respect to gradients (γU, γN, γO) at under-exposure, correct exposure and over-exposure.

First, there will be described the Crm value relating the equation (1).

As a result of detailed analysis of density distribution of photographed scenes taken by general users using various cameras, it was found that when metric chroma C_{ab}* values were determined with respect to each of Blue, Green, Red, Yellow, Magenta and Cyan as basic colors of color images and a total value of values at under-exposure, normal exposure and over-exposure was more than a prescribed value, it was recognized to be satisfactory color reproduction for users.

When a Macbeth color chart (having 24 squares) having been photographed with photographic material using a camera under a sun light source having a color temperature of 4800° K at each of a correct exposure (N), an under-exposure (U) of 2 stops down from the correct exposure in which the aperture of the camera is reduced by 2 stops from that of the correct exposure and an over-exposure (O) of 2 stops up from the correct exposure in which the aperture of the camera is increased by 2 stops from that of the correct exposure and after having been processed, for example, in accordance with color processing described in JP-A No. 10-123652, paragraph Nos. [0220] to [0227], the process photographic material is printed on a color print paper with respect to the respective exposures under an exposure condition such that N5 gray of the Macbeth color chart (gray chart of 18% reflectance) gives values of L*=50, a*=0 and b*=0, metric chroma C_{ab}* values are determined with respect to Blue, Green, Red, Yellow, Magenta and Cyan of the color chart for each of the foregoing exposures and the a total value of values at the under-exposure condition, correct exposure condition and the over-exposure condition is to be the Crm value of the invention.

In the invention, the L*, a* and b* values are color coordinates represented by CIE 1976 (L*,a*,b*) space, and colorimetric calculation is made using-standard light source C as an observation light to obtain tristimulus values. The L*. a* and c* values are commonly known in the art, as described, for example, in U.S. Pat. No. 5,362,616, and can also be determined by the method described in “Shikisai Kagaku Handbook (New Edition)”, pages 83-146 and 182-255 (edited by Nippon Shikisai-Gakkai, published by Tokyo Daigaku Shuppankai).

The metric chroma C_{ab}* defined in the invention is a perceived quantity in the CIE 1976 (L*,a*,b*) space and can be determined by the method described in “Shikisai Kagaku Handbook (New Edition)”, page 277. Thus, chromaticity of a photographic material for camera use is measured using a color analyzer (e.g., CMS-1200, produced by Murakami Shikisai Co., Ltd.) and the chromaticity point in the L*a*b* space is determined using a color matching function at a visual field of 2° and a standard light source, C light source.

The nominal speed, designated as “S”, refers to the numeral indicated subsequent to designation “ISO” on the outside of a cartridge, cartridge or a vessel housing photographic film of commonly known 135 size, IV 240 Type and the like. Alternatively, on the outer surface of the metallic container of 135 size roll film (also called cartridge), a portion comprised of a conductive section and non-conductive section, a so-called CAS portion is provided to detect the film speed, and the nominal speed is the speed value indicated when the cartridge is loaded in a camera. Speed of photographic material is represented in various ways in different countries. The nominal speed in the invention is expressed in ISO speed, which is used as an international designation. In the invention, S is preferably not less than 100 and not more than 800.

The Crm value of the invention is characterized to be more than (1045−log₁₀S×75). For example, it is to be more than 895 for a photographic material of a nominal speed of 100, it is to be more than 872 for a photographic material of a nominal speed of 200, it is to be more than 850 for a photographic material of a nominal speed of 400 and it is to be more than 828 for a photographic material of a nominal speed of 800.

Next, there will be described the gradient defined in equation (2). As a result of detailed analysis of density distribution of photographed scenes taken by general users using various cameras, it was proved that the contrast in the under-exposure region is lowered that in the normal exposure region and the contrast in the over-exposure region tends to be lowered due to a decrease in latitude. Accordingly, under- or over-exposure caused lowering in print quality, compared to normal exposure.

As a result of further detailed analysis, it was found that print stability of from under-exposed scenes to over-exposed scenes could be maintained by setting gradients at under-, normal and over-exposures to be in a specific ratio for every nominal film speed.

In the invention, the gradient can be determined in the manner described below. A silver halide color photographic material is exposed through an optical wedge for 1/200 sec. using a light source of a color temperature of 4800° K. Subsequently, the photographic material is subjected to prescribed processing, for example, color processing in accordance with the processing steps described in JP-A No. 10-123652, paragraph [0220]-[0227]. The formed image density is measured using a transmission optical densitometer, for example, X-rite densitometer to prepare characteristic curves for yellow, magenta and cyan, comprised of an abscissa of exposure (logE) and an ordinate of density (D), from which a slope of a straight line between connected exposure points described earlier, is determined and is referred to as a gradient.

In the silver halide color photographic material of the invention, any method can be employed as a means for achieving the requirements defined in equations (1) and (2) but appropriate selection or combination of the following means is preferred, however, the invention is not limited to these methods:

1. A method in which individual light-sensitive layers are each composed of two or more component layers and suitable silver halide emulsions (grain size, grain shape, halide composition, addition amount or silver content) and the kind or amount of spectral sensitizing dyes are optimally chosen;

2. A method in which individual light-sensitive layers are each composed of two or more component layers and colorless couplers suitable for each of the layers (e.g., reaction rate, spectral absorption characteristics after dye formation, addition amount) are optimally chosen;

3. A method in which individual light-sensitive layers are each composed of two or more component layers and colored couplers suitable for each of the layers (e.g., kind, addition amount) are optimally chosen;

4. A method in which individual light-sensitive layers are each composed of two or more component layers and a DIR coupler is used in a specific component layer, and the kind of the DIR coupler (reaction rate, diffusibility of an inhibitor component, inhibition degree) and its amount are optimally chosen;

5. A method in which the dry thickness and the hardening degree of the respective component layers are optimally adjusted to control diffusion of the inhibitor component of a DIR coupler; and

6. A method in which a compound capable of trapping an oxidation product of a developing agent is added to an interlayer provided between light-sensitive layers differing in spectral sensitivity.

A silver halide color photographic material comprising on a support a red-sensitive layer, a green-sensitive layer and a blue-sensitive layer, characterized in that after having been subjected to color photographic processing, the photographic material satisfies a quality value QC as defined in the foregoing equation (4); the red-sensitive layer, the green-sensitive layer and the blue-sensitive layer each satisfy the foregoing equations (2) with respect to gradients (γU, γN, γO) at under-exposure, correct exposure and over-exposure.

The quality value, QC is a parameter indicating the extent of color balance of a finished print of an under-exposed scene, that is, print level variation.

As a result of the study of methods for decreasing print level variation of commercially available printers and enhancing finished print quality, it was proved that normal exposure conditions not being determined in the printer was a factor of increasing the print level variation. From analysis of problems of finished print quality, it was further proved that low contrast of the obtained print image was a cause thereof.

However, allowing both problems described above to exist simultaneously means treating the under-exposed scene and the correctly exposed scene as the same characteristic, leading to an increase of the silver content of a photographic material for photographing (or camera material) and producing problems such as silver retention, increased fogging density and increased cost, which are by no means effective. As a means for increasing contrast in the toe portion on a characteristic curve which is used in the under-exposed cameral material is cited a method of using large silver halide grains to increase the ISO speed. In fact, enhancing the effective speed in printing can be achieved to some extent. On the contrary, however, the use of large silver halide grains produces rough graininess of the subsequent printed image, often producing complaints of prints being unacceptable to the photographer. It was further proved that even if the effective speed was enhanced by the foregoing method, color contrast was insufficient and proper printing conditions could not be determined, which was not so effective to reduce print level variation.

The invention was achieved in view of the foregoing problems. Thus, exposure conditions of a printer are set, as follows: the overall exposure condition has up to now been controlled based on neutral densities so as to raise or lower the finished density. In the invention, when separated color densities, specifically those in under-exposures are different, a correction value is calculated and the relationship between quality value QC as the correction value and the nominal speed of the photographic material is specified to provide a print exhibiting a stable color balance even when photographed at under-exposure. In the invention, quality value QC is represented by rounding a calculated value to one decimal point.

According to the foregoing equation (4), the quality value QC relating to the invention is 2.8 or more for photographic material of nominal film speed of 100, 2.2 or more for photographic material of nominal film speed 200, 1.7 or more for photographic material of nominal film speed 400, and 1.3 or more for photographic material of nominal film speed 800.

Next, quality value QC will be detailed:
QC≧15.982×S^{-0.378} equation (4)
wherein S represents the nominal speed of a photographic material and QC is determined in accordance with the process comprising the steps of:

photographing a Macbeth color chart which is set up as a checkerboard array of 24 squares including color chart and neutral gray chart (i.e., 6 grades of neutral gray and 18 kinds of colors other than gray) with the photographic material under a light source having a color temperature of 4800° K using a camera at an under-exposure of 3 stops-down from normal exposure in which the aperture of the camera is reduced by 3 steps from that of the normal exposure,

processing the thus exposed photographic material in a prescribed color processing, for example, the process described in paragraph [0220]-[0227] of JP-A No. 10-123652, as described later,

printing the processed photographic material on a color paper to produce a color print, under such exposure conditions that the area on the print, corresponding to Neutral 5 (or N5) gray area of the Macbeth color chart (which is a neutral gray area exhibiting a reflectance of 18%) gives values of L*=50, a*=0 and b*=0,

subjecting the color print to chromaticity measurement to determine chroma values of areas on the print corresponding to 18 colors other than gray of the Macbeth color chart, and

calculating the foregoing QC value according to the following equation (5):
QC=(Cr+Ch)/2 equation (5)
wherein Cr and Ch are defined as

Cr=20×log₁₀(Cr0) and Ch=7.0−3×log₁₀(Ch0), wherein Cr0 is the ratio of the mean value of metric chroma values C_{ab}* of 18 colors of the Macbeth color chart to the mean value of chroma values of the areas on the print corresponding to the 18 colors of the Macbeth color chart; and the absolute value of the difference in angle between a color vector of each of the 18 colors of the Macbeth color chart and that of an area on the print corresponding to each of the 18 colors is determined and the average value of the thus determined absolute values of the 18 colors is defined as Ch0.

In the silver halide color photographic material of the invention, the means for achieving the requirement defined in equation (4) is not specifically limited but appropriate selection of the means 1 to 6 described above or the combination thereof is preferred.

In the silver halide color photographic material of the invention, the total coating weight of silver, which is represented by an equivalent converted to metallic silver, preferably is a silver amount value B (g/m²) defined in the following equation (8):
B≦10.0−10^{(-0.005×S+0.85)} equation (8)
wherein S is a nominal film speed and preferably 100 to 800.

A silver halide color photographic material having a silver amount value in proportion to the nominal speed S can optimize ultimate speed and ultimate image quality and performs proper desilvering in various processes, whereby the S/N ratio in the negative to positive conversion of a negative film image in digital printing can be improved.

The silver amount value (B) defined in the equation (8) is 3.4 (g/m²) or less for photographic material of a nominal film speed of 100, 3.8 (g/m²) or less for photographic material of a nominal film speed 200, 4.6 (g/m²) or less for photographic material of a nominal film speed 400, and 5.9 (g/m²) or less for photographic material of a nominal film speed 800.

Next, there will be described constituent elements of the silver halide color photographic material of the invention.

In the preparation of silver halide emulsions relating to the invention are usable materials described in Research Disclosure NO. 308119 (hereinafter, also denoted simply as RD308119). Relevant portions are shown below.

| Item | RD 308119 |
|---|---|
| Iodide composition | 993, I-A |
| Preparation method | 993, I-A; 994, I-E |
| Crystal habit (regular crystal) | 993, I-A |
| Crystal habit (twinned crystal) | 993, I-A |
| Epitaxial | 993, I-A |
| Homogeneous halide composition | 993, I-B |
| Inhomogeneous halide composition | 993, I-B |
| Halide conversion | 994, I-C |
| Halide substitution | 994, I-C |
| Metal occlusion | 994, I-D |
| Monodispersibility | 995, I-F |
| Solvent addition | 995, I-F |
| Latent image forming site (surface) | 995, I-G |
| Latent image forming site (internal) | 995, I-G |
| Photographic material (negative) | 995, I-H |
| Photographic material (positive, | 995, I-H |
| including internally fogged grains) | |
| Emulsion blending | 995, I-I |
| Desalting | 995, II-A |

Silver halide emulsions according to the invention are subjected to physical ripening, chemical ripening and spectral sensitization. As additives used in these processes are shown compounds described in Research Disclosure RD 17643, RD 18716 and RD 308119), as below.

| Item | RD 308119 | RD 17643 | RD 18716 |
|---|---|---|---|
| Chemical Sensitizer | 996, III-A | 23 | 648 |
| Spectral Sensitizer | 996, IV-A-A, B, C, | 23-24 | 648-9 |
| | D, H, I, J | | |
| Super Sensitizer | 996, IV-A-E, J | 23-24 | 648-9 |
| Antifoggant | 998, VI | 24-25 | 649 |
| Stabilizer | 998, VI | 24-25 | 649 |

Photographic additives usable in the invention are also described, as shown below.

| Item | RD 308119 | RD 17643 | RD 18716 |
|---|---|---|---|
| Anti-staining Agent | 1002, VII-I | 25 | 650 |
| Dye Image-Stabilizer | 1001, VII-J | 25 | |
| Britening Agent | 998, V | 24 | |
| U.V. Absorbent | 1003, VIII-I, XIII-C | 25-26 | |
| Light Absorber | 1003, VIII | 25-26 | |
| Light-Scattering | 1003, VIII | | |
| Agent | | | |
| Filter Dye | 1003, VIII | 25-26 | |
| Binder | 1003, IX | 26 | 651 |
| Anti-Static Agent | 1006, XIII | 27 | 650 |
| Hardener | 1004, X | 26 | 651 |
| Plasticizer | 1006, XII | 27 | 650 |
| Lubricant | 1006, XII | 27 | 650 |
| Surfactant, | 1005, XI | 26-27 | 650 |
| Coating Aid | | | |
| Matting Agent | 1007, XVI | | |
| Developing Agent | 1001, XXB | | |
| (incorporated in | | | |
| photographic material) | | | |

A variety of couplers can be employed in the invention and examples thereof are described in research Disclosures described above. Relevant description portions are shown below.

| Item | RD 308119 | RD 17643 |
|---|---|---|
| Yellow coupler | 1001, VII-D | VII-C˜G |
| Magenta coupler | 1001, VII-D | VII-C˜G |
| Cyan coupler | 1001, VII-D | VII-C˜G |
| Colored coupler | 1002, VII-G | VII-G |
| DIR coupler | 1001, VII-F | VII-F |
| BAR coupler | 1002, VII-F | |
| PUG releasing coupler | 1001, VII-F | |
| Alkali-soluble coupler | 1001, VII-E | |

Additives used in the invention can be added by dispersion techniques described in RD 308119 XIV. In the photographic material relating to the invention, there can be provided auxiliary layers such as a filter layer and interlayer, as described in RD 308119 VII-K, and arranged in a variety of layer orders such as normal layer order, reverse layer order and a unit layer arrangement.

The photographic material relating to this invention can be processed using commonly known developers described in T. H. James “The Theory of The Photographic Process” Forth Edition, pp. 291-334; and J. Am. Chem. Soc. Vol. 73, pp. 3100 (1951), according to the conventional methods, as described in, cited above, RD38957, items XVII through XX and RD40145, item XXII.

The present invention will be further described, based on examples, but the invention is by no means limited to these embodiments.

Preparation of Sample 101

On a 125 μm thick, subbed triacetyl cellulose film support, the following layers having composition as shown below were successively formed from the support side to prepare a multi-layered color photographic material sample 101. The addition amount of each compound was represented in term of g/m², unless otherwise noted. The amount of silver halide or colloidal silver was converted to the silver amount and the amount of a sensitizing dye (denoted as “SD”) was represented in mol/Ag mol.

| 1st Layer: Anti-Halation Layer | |
|---|---|
| Black colloidal silver | 0.13 |
| UV-1 | 0.30 |
| CM-1 | 0.11 |
| OIL-1 | 0.23 |
| Gelatin | 1.20 |
| 2nd Layer: Interlayer | |
| OIL-3 | 0.267 |
| Gelatin | 0.89 |
| 3rd Layer: Low-speed Red-sensitive Layer | |
| Silver iodobromide emulsion a | 0.31 |
| Silver iodobromide emulsion c | 0.22 |
| SD-1 | 1.28 × 10⁻⁴ |
| SD-2 | 1.78 × 10⁻⁵ |
| SD-3 | 8.40 × 10⁻⁵ |
| C-1 | 0.324 |
| CC-1 | 0.056 |
| D-1 | 0.014 |
| AS-2 | 0.002 |
| OIL-2 | 0.320 |
| Gelatin | 1.06 |
| 4th Layer: Medium-speed Red-sensitive Layer | |
| Silver iodobromide emulsion b | 0.08 |
| Silver iodobromide emulsion d | 0.40 |
| SD-1 | 2.56 × 10⁻⁴ |
| SD-2 | 3.50 × 10⁻⁵ |
| SD-3 | 1.72 × 10⁻⁴ |
| C-1 | 0.219 |
| CC-1 | 0.044 |
| D-1 | 0.010 |
| D-3 | 0.002 |
| AS-2 | 0.002 |
| OIL-2 | 0.001 |
| Gelatin | 0.84 |
| 5th Layer: High-speed Red-sensitive Layer | |
| Silver iodobromide emulsion d | 0.10 |
| Silver iodobromide emulsion g | 0.42 |
| SD-1 | 7.11 × 10⁻⁵ |
| SD-2 | 9.78 × 10⁻⁶ |
| SD-3 | 4.72 × 10⁻⁵ |
| C-1 | 0.046 |
| C-2 | 0.041 |
| CC-1 | 0.019 |
| D-3 | 0.003 |
| AS-2 | 0.001 |
| OIL-2 | 0.088 |
| Gelatin | 0.84 |
| 6th Layer: Interlayer | |
| OIL-1 | 0.25 |
| Gelatin | 0.91 |
| 7th Layer: Low-speed Green-sensitive Layer | |
| Silver iodobromide emulsion b | 0.23 |
| Silver iodobromide emulsion c | 0.10 |
| SD-4 | 1.17 × 10⁻⁴ |
| SD-5 | 1.28 × 10⁻⁵ |
| SD-6 | 1.61 × 10⁻⁵ |
| M-1 | 0.275 |
| CM-1 | 0.085 |
| D-2 | 0.001 |
| D-3 | 0.001 |
| AS-2 | 0.001 |
| X-2 | 0.069 |
| AS-3 | 0.033 |
| OIL-1 | 0.410 |
| Gelatin | 1.14 |
| 8th Layer: Medium-speed Green-sensitive Layer | |
| Silver iodobromide emulsion c | 0.09 |
| Silver iodobromide emulsion d | 0.40 |
| SD-4 | 3.83 × 10⁻⁴ |
| SD-5 | 4.00 × 10⁻⁵ |
| SD-6 | 5.00 × 10⁻⁵ |
| M-1 | 0.101 |
| CM-1 | 0.039 |
| D-2 | 0.001 |
| D-3 | 0.005 |
| AS-2 | 0.001 |
| X-2 | 0.014 |
| AS-3 | 0.007 |
| OIL-1 | 0.280 |
| Gelatin | 1.06 |
| 9th Layer: High-speed Green-Sensitive Layer | |
| Silver iodobromide emulsion f | 0.60 |
| SD-4 | 1.01 × 10⁻⁴ |
| SD-5 | 3.78 × 10⁻⁵ |
| SD-6 | 6.33 × 10⁻⁶ |
| M-1 | 0.058 |
| CM-1 | 0.029 |
| AS-2 | 0.001 |
| X-2 | 0.015 |
| AS-3 | 0.007 |
| OIL-1 | 0.141 |
| Gelatin | 1.11 |
| 10th Layer: Yellow Filter Layer | |
| Yellow colloidal silver | 0.06 |
| AS-1 | 0.02 |
| OIL-1 | 0.09 |
| Gelatin | 0.90 |
| 11th Layer: Low-speed Blue-sensitive Layer | |
| Silver iodobromide emulsion b | 0.11 |
| Silver iodobromide emulsion d | 0.20 |
| Silver iodobromide emulsion e | 0.20 |
| SD-7 | 2.78 × 10⁻⁴ |
| SD-8 | 7.17 × 10⁻⁵ |
| Y-1 | 0.925 |
| AS-2 | 0.003 |
| OIL-1 | 0.371 |
| Gelatin | 1.91 |
| 12th Layer: High-sped Blue-sensitive Layer | |
| Silver iodobromide emulsion e | 0.03 |
| Silver iodobromide emulsion h | 0.25 |
| SD-7 | 2.78 × 10⁻⁵ |
| SD-8 | 1.83 × 10⁻⁵ |
| Y-1 | 0.078 |
| AS-2 | 0.001 |
| D-4 | 0.038 |
| OIL-1 | 0.047 |
| Gelatin | 0.61 |
| 13th Layer: First Protective Layer | |
| Silver iodobromide emulsion i | 0.22 |
| UV-1 | 0.10 |
| UV-2 | 0.06 |
| X-1 | 0.04 |
| Gelatin | 0.70 |
| 14th Layer: Second protective Layer | |
| PM-1 | 0.10 |
| PM-2 | 0.018 |
| WAX-1 | 0.02 |
| SU-1 | 0.003 |
| Gelatin | 0.55 |

In addition to the above composition were added coating aids SU-1, SU-2 and SU-3; a dispersing aid SU-4; viscosity-adjusting agent V-1; stabilizer ST-1; two kinds polyvinyl pyrrolidone of weight-averaged molecular weights of 10,000 and 1,100,000 (AF-1, AF-2); calcium chloride; inhibitors AF-3, AF-4, AF-5, Af-6 and AF-7; hardener H-1; and antiseptic Ase-1.

Characteristics of silver iodobromide emulsions used in sample 101, which were prepared in accordance with conventional method are shown below, in which the average grain size of silver iodobromide emulsions c, d, e, f, g and h refers to an equivalent circular diameter and that of silver iodobromide emulsions a, b and I refers to an edge length of a cube having the same volume as that of the grain.

| | Av. Grain | Av. Iodide | Av. Aspect |
|---|---|---|---|
| Emulsion | Size (μm) | Content (mol %) | Ratio |
| a | 0.27 | 2.0 | — |
| b | 0.28 | 2.0 | — |
| c | 0.61 | 3.1 | 5.43 |
| d | 0.89 | 3.7 | 6.10 |
| e | 0.95 | 8.0 | 3.07 |
| f | 1.43 | 5.0 | 6.76 |
| g | 1.50 | 3.1 | 6.60 |
| h | 1.23 | 7.9 | 2.85 |
| i | 0.043 | 1.9 | — |

With regard to the foregoing emulsions, except for emulsion i, after adding the foregoing sensitizing dyes to each of the emulsions and ripening the emulsions, triphenylphosphine selenide, sodium thiosulfate, chloroauric acid and potassium thiocyanate were added and chemical sensitization was conducted according to the commonly known method until relationship between sensitivity and fog reached an optimum point.

The thus prepared sample 101 was proved to exhibit a nominal speed of 200 and a total silver coating weight of 4.15 g/m².

The Crm value and quality value QC of sample 101, which were determined according to the methods described later, were 840 and 2.1, respectively.

Preparation of Sample 102 to 108

Samples 102 to 108 were prepared similarly to sample 101, provided that the average grain size, aspect ratio, chemical sensitization conditions and silver amount value of silver iodobromide emulsions in the respective light-sensitive layers, and couplers (including colored couplers) used in the respective light-sensitive layers and amounts of a DIR coupler and an AS agent used in the interlayer were optimally adjusted so that the nominal film speed, Crm value and quality value QC were achieved as shown below.

Determination of Crm Value

The thus prepared samples 101 to 108 were each put into a cartridge and loaded into a commercially available single lens reflex camera.

Using this camera, a Macbeth color chart (having 24 squares) was photographed under a sun light source having a color temperature of 4800° K at a correct exposure condition (N), at an under-exposure condition (U) of 2 stops-down from the correct exposure condition in which the aperture of the camera was reduced by 2 steps from that of the correct exposure and at an over-exposure condition (O) of 2 stops-up from the correct exposure in which the aperture of the camera was increased by 2 steps from that of the correct exposure, and after having been processed in accordance with color processing described in JP-A No. 10-123652, paragraph Nos. [0220] to [0227], the processed photographic materials having exposed at the foregoing exposure conditions were each printed on a color print paper under such exposure conditions that N5 gray of the Macbeth color chart (gray chart of 18% reflectance) gives values of L*=50, a*=0 and b*=0, metric chroma C_{ab}* values corresponding to Blue, Green, Red, Yellow, Magenta and Cyan of the color chart were determined and totalized, and the total value thereof was defined as the Crm value of the invention.

The chromaticity of the photographic material was measured using a color analyzer (e.g., CMS-1200, produced by Murakami Shikisai Co., Ltd.) and the chromaticity point in the L*a*b* space was determined using a color matching function at a visual field of 2° and a standard light source, C light source.

Determination of Gradient

The gradient was determined in the manner described below. Samples each were exposed through an optical wedge for 1/200 sec. using a light source of a color temperature of 4800° K. Subsequently, the samples were subjected to color processing in accordance with the processing steps described in JP-A No. 10-123652, paragraph [0220]-[0227]. The formed image density was measured using a transmission optical densitometer, for example, X-rite densitometer to prepare characteristic curves for yellow, magenta and cyan, comprised of an abscissa of exposure (logE) and an ordinate of density (D), from which a slope of a straight line connecting between the exposure points described earlier was determined and defined as a gradient. The gradient γU, γN and γO were each determined by the following definition:
γU: a slope (tanθ) of a straight line connecting an exposure point (−0.1−log₁₀S) and an exposure point (0.9−log₁₀S)
γN: a slope (tanθ) of a straight line connecting an exposure point (0.5−log₁₀S) and an exposure point (1.5−log₁₀S),
γO: a slope (tanθ) of a straight line connecting an exposure point (2.0−log₁₀S) and an exposure point (3.0−log₁₀S).
   Determination of Quality Value QC

Samples 101 through 108 were each packed into a cartridge and loaded into a commercially available single-lens reflex camera. Using the camera, a Macbeth color chart (comprised of 24 colored squares) was photographed under a light source having a color temperature of 4800° K with varying an exposure in which the aperture of the camera is reduced by 4 steps from the normal exposure (hereinafter, also referred to as −4 under-exposure) to an exposure in which the aperture was increased by 1 step from the normal exposure (hereinafter, also referred to as +1 over-exposure). Further, 100 shots for each of an outdoor scene against light and a stroboscopic (electronic-flashed) scene were photographed with varying an object distance by 4 steps and changing background colors of gray, white, black, green and yellow at varying exposure from −2 under-exposure to +1 over-exposure, while varying the number of objects from one person to five persons. Furthermore, scenes with a lighter background than the object, such as white wall or blue sky were photographed through center-weighted metering at an exposure ranging from −1 under-exposure to +1 over-exposure, including normal exposure. The thus exposed samples were subjected to color processing in accordance with processing steps described in JP-A No. 10-123652, col. [0220] through [0227] and the quality value QC was determined according to the foregoing method.

The thus obtained results are shown below.

| | | Total coating | | |
|---|---|---|---|---|
| Sample | Nominal | Weight of | | |
| No. | Speed | Silver (g/m²) | Crm Value | Remark |
| 102 | 100 | 3.57 | 852 | Comp. |
| 101 | 200 | 4.15 | 840 | Comp. |
| 103 | 400 | 4.85 | 828 | Comp. |
| 104 | 800 | 7.05 | 803 | Comp. |
| 105 | 100 | 3.20 | 902 | Comp. |
| 106 | 200 | 3.70 | 880 | Comp. |
| 107 | 400 | 4.40 | 854 | Comp. |
| 108 | 800 | 5.40 | 833 | Comp. |
| 109 | 100 | 3.20 | 912 | Inv. |
| 110 | 200 | 3.70 | 889 | Inv. |
| 111 | 400 | 4.40 | 868 | Inv. |
| 112 | 800 | 5.40 | 841 | Inv. |

| Sample | Nominal | Quality | Gradient | | |
|---|---|---|---|---|---|
| No. | Speed | Value QC | γU/γN | γO/γN | Remark |
| 102 | 100 | 2.6 | 0.90 | 0.92 | Comp. |
| 101 | 200 | 2.1 | 0.87 | 0.89 | Comp. |
| 103 | 400 | 1.5 | 0.86 | 0.87 | Comp. |
| 104 | 800 | 1.1 | 0.82 | 0.88 | Comp. |
| 105 | 100 | 2.9 | 0.93 | 0.94 | Comp. |
| 106 | 200 | 2.2 | 0.92 | 0.93 | Comp. |
| 107 | 400 | 1.7 | 0.90 | 0.92 | Comp. |
| 108 | 800 | 1.4 | 0.88 | 0.90 | Comp. |
| 109 | 100 | 3.0 | 0.99 | 1.02 | Inv. |
| 110 | 200 | 2.4 | 0.98 | 1.00 | Inv. |
| 111 | 400 | 1.8 | 0.98 | 0.99 | Inv. |
| 112 | 800 | 1.6 | 0.96 | 0.98 | Inv. |

Values of γU/γN and γO/γN for the red-sensitive layer, the green-sensitive layer and the blue-sensitive layer were each approximately close to each other, therefore, only gradient values of the green-sensitive layer were shown above.

Color Change and Image Quality Evaluation of Print

Prints of under-exposed scenes, printed by an analog printer were evaluated with respect to color quality, in the following manner. Samples 101 through 108 were each packed into a cartridge and loaded into a commercially available single-lens reflex camera (denoted as camera A) and a fixed-focus, fixed-aperture, single shutter speed camera (denoted as camera B). There were set scenes of dusk and indoor as an under-exposure scene, usually corresponding to 2 stop-under; scenes of outdoor front-lighting portrait under daylight, as a normal exposure scene; and scenes with a lighter background than the object, such as white wall or a sandy beach, as a over-exposure scene, usually corresponding to 2 stop-over. The respective scenes were randomly photographed using the cameras described above.

The thus exposed samples were processed in accordance with color-processing steps described in JP-A No. 10-123652, [0220] through [0227] and were printed on color print paper (Color Paper QA Type A7, produced by Konica Corp.) using an analog printer (Nice Print System NPS 858, one-channel type, produced by Konica Corp.) and processed (by Konica CPK-2-21) to output 100 prints per sample. The thus obtained prints were evaluated by 10 people (general users) with respect to color image quality of finished prints (print level), based on the following 4 criteria:

A: finished prints with excellent contrast and color reproduction from under-exposure scenes to over-exposure scenes,

B: finished prints with almost favorable contrast and color reproduction from under-exposure scenes to over-exposure scenes,

C: fluctuation in color and a lowering in contrast being slightly observed in under-exposure scenes and over-exposure scenes,

D: fluctuation in color and a lowering in contrast being apparently observed in all scenes of under-exposure scenes to over-exposure scenes.

Prints of under-exposed scenes, printed by a digital printer were also evaluated with respect to color quality, as follows. Of samples prepared for-evaluation by using an analog printer, samples which were photographed by using camera B and processed, were printed on color print paper (Color Paper QA Type A7, produced by Konica Corp.) at a L print size (printing magnification: 4.5 times) using a digital printer (KONICA QD21, produced by Konica Corp.) and processed (by Konica CPK-2-21) to output 100 prints per sample. The thus obtained prints were visually evaluated by 10 people (general users) with respect to color image quality of finished prints, compared to prints obtained by an analog printer in Example 1, and were graded based on the following 4 criteria:

A: excellent contrast conversion having been performed in under-exposure and over-exposure scenes, and having no problem in other print qualities, compared to analog prints;

B: favorable contrast conversion having been performed in under-exposure and over-exposure scenes, and having no problem in other print qualities, compared to analog prints;

C: contrast being substantially equivalent to analog prints and no problem in finished prints; and

D: unnatural prints with excessively enhanced contrast, compared to analog prints, being judged to be outside a permissible range.

Of the foregoing samples photographed by the camera B, scenes of the under-exposure and correct exposure conditions were printed using a digital printer (KONICA QD21, produced by Konica Corp.) to prepare prints. The digital printer was operated so that local printing was automatically done. The thus obtained prints were evaluated by 10 people having experience in using the printer with respect to color image quality of finished prints (print level), taking account of occurrence of variation of print level from the preferred neutral level, based on the following criteria:

A: excellently finished prints within less than 5% of color correction in printer;

B: occurrence of prints necessary to make 5 to 10% correction based on color buttons being less than 10%, leading to almost favorable finished prints;

C: occurrence of prints necessary to make 5 to 10% correction based on color buttons being 10 to 30%, falling within levels acceptable in practice;

D: occurrence of prints necessary to make 10 to 30% correction based on color buttons being within 30%, leading to unacceptable levels in practice.

Results obtained in the foregoing evaluation are shown below.

| | Analog Printer | | Digital Printer | | |
|---|---|---|---|---|---|
| Sample | Camera | Camera | Contrast | Color | |
| No. | (A) | (B) | Color Reproduction | Quality | Remark |
| 101 | A | C | C | C | Comp. |
| 102 | B | D | C | D | Comp. |
| 103 | C | D | C | D | Comp. |
| 104 | C | D | D | D | Comp. |
| 105 | A | C | B | C | Comp. |
| 106 | A | C | C | C | Comp. |
| 107 | B | D | C | D | Comp. |
| 108 | B | D | D | D | Comp. |
| 109 | A | A | A | A | Inv. |
| 110 | A | B | A | A | Inv. |
| 111 | A | B | B | B | Inv. |
| 112 | B | C | B | B | Inv. |

### INDUSTRIAL APPLICABILITY

According to the invention, there was provided a silver halide color photographic material of a relatively low silver content suitable for digital print, whereby print quality superior in contrast and color reproduction was achieved irrespective of camera quality used for picture-taking.

1. A silver halide color photographic material comprising on a support a red-sensitive layer, a green-sensitive layer and a blue-sensitive layer, wherein after subjected to color processing, the photographic material satisfies equation (1) below with respect to Crm values which are defined as below and calculated for under-exposure, correct exposure and over-exposure; the red-sensitive layer, the green-sensitive layer and the blue-sensitive layer each satisfy the following equations (2) and (3) with respect to gradients (γU, γN, γO) for under-exposure, correct exposure and over-exposure;
Crm≧1045−log₁₀S×75 equation (1)
wherein S is a nominal speed of the photographic material, and Crm is defined as follows:
when a Macbeth color chart (having 24 squares) having been photographed with the photographic material using a * camera under a sun light source having a color temperature of 4800° K at each of a correct exposure (N), an under-exposure (U) of being 2 stops down from the correct exposure and an over-exposure (O) of being 2 stops up from the correct exposure and after having been processed, the photographic material is printed on a color print paper with respect to the respective exposures under such an exposure condition that N5 gray of the Macbeth color chart (gray chart of 18% reflectance) gives values of L*=50, a*=0 and b*=0, metric chroma C_{ab}* values are determined for Blue, Green, Red, Yellow, Magenta and Cyan of the color chart at each of the under-exposure, the correct exposure and the over-exposure and the Crm value is a total value of the metric chroma values at the under-exposure condition, correct exposure condition and the over-exposure condition;
0.92≦γU/γN≦1.05 equation (2)
0.92≦γO/γN≦1.05 equation (3)
wherein when a density function curve (D-logE) indicating a relationship between exposure and color density is prepared for the photographic material processed, the γU, γN and γO are each determined by the following definition:
γU: a slope (tanθ) of a straight line connecting an exposure point (−0.1−log₁₀S) and an exposure point (0.9−log₁₀S),
γN: a slope (tanθ) of a straight line connecting an exposure point (0.5−log₁₀S) and an exposure point (1.5−log₁₀S),
γO: a slope (tanθ) of a straight line connecting an exposure point (2.0−log₁₀S) and an exposure point (3.0−log₁₀S).

2. A silver halide color photographic material comprising on a support a red-sensitive layer, a green-sensitive layer and a blue-sensitive layer, wherein after subjected to color photographic processing, the photographic material satisfies the following equation (4) with respect to a quality value QC as defined as below; the red-sensitive layer, the green-sensitive layer and the blue-sensitive layer each satisfy the foregoing equations (2) with respect to gradients (γU, γN, γO) at under-exposure, correct exposure and over-exposure,
QC≧15.982×S^{-0.378} equation (4)
wherein S is a nominal speed and preferably from 100 to 800; and QC is defined as below;
when a Macbeth color chart (24 squares) having been photographed with the photographic material using a camera under a light source having a color temperature of 4800° K at an under-exposure of 3 stops-down from normal exposure in which the aperture of the camera is reduced by 3 steps from the normal exposure and after having been processed, the photographic material is exposed to obtain a print under the exposure condition so that N5 gray of the Macbeth color chart (gray chart of 18% reflectance) gives values of L*=50, a*=0 and b*=0 and 18 colors other than gray are subjected to chromaticity measurement, the quality value of QC is calculated according to the following equation (5):
QC=(Cr+Ch)/2 equation (5)
wherein Cr and Ch are defined in the following equations (6) and (7):
Cr=20×log₁₀(Cr0) equation (6)
Ch=7.0−3×log₁₀(Ch0) equation (7)
wherein Cr0 represents a ratio of a mean metric chroma value C_{ab}* calculated from chromaticity values of 18 colors of the Macbeth color chart to a mean metric chroma value C_{ab}* calculated from chromaticity values of 18 colors of the print of the Macbeth color chart; and when from color vectors of the 18 colors of the Macbeth color chart and the respective color vectors of the print corresponding to the Macbeth color chart, chromaticity fluctuations for the respective colors are represented by an angle between the foregoing color vectors for each of the 18 colors, and a mean value of the chromaticity fluctuations is designated as Ch0.

3. The silver halide color photographic material according to claim 1, wherein the total coating weight of silver is a silver amount B (g/m²) as defined in the following equation (8):
B≦10.0−10^{(-0.005×S+0.85)} equation (8)
wherein S is a nominal speed of the photographic material.

4. The silver halide color photographic material according to claim 1, wherein the nominal speed S is from 100 to 800.

5. The silver halide color photographic material according to claim 2, wherein the total coating weight of silver is a silver amount B (g/m²) as defined in the following equation (8):
B≦10.0−10^{(-0.005×S+0.85)} equation (8)
wherein S is a nominal speed of the photographic material.

6. The silver halide color photographic material according to claim 2, wherein the nominal speed S is from 100 to 800.

7. The silver halide color photographic material according to claim 3, wherein the nominal speed S is from 100 to 800.

8. The silver halide color photographic material according to claim 5, wherein the nominal speed S is from 100 to 800.
